(19) United States
(12) Patent Application Publication
(10) Pub. No.: US 2003/0204727 A1
(43) Pub. Date: Oct. 30, 2003

(54) Method and apparatus for embedding information in content, method and apparatus for reconstructing content, and method and apparatus for extracting information

(76) Inventor: Minoru Sasaki, Tokyo (JP)

Correspondence Address: McGinn & Gibb, PLLC, Suite 200, 8321 Old Courthouse Road, Vienna, VA, 22182-3817, US

(21) Appl. No.: 10/128,234

(22) Filed: Apr. 24, 2002

(51) Int. Cl. H04L 9/00

(52) U.S. Cl. 713/176

(57) ABSTRACT

Disclosed are an information embedding method and apparatus for embedding watermark data in programs and compressed data. The method includes generating encoded content by attaching an error correction code to content, and generating watermark-embedded encoded content by embedding watermark data in the encoded content that has been generated. The watermark data has such data length that the watermark data can be removed if decoding processing is executed using the error correction code. The original content can be obtained from the watermark-embedded encoded content by decoding processing based upon the error correction code that has been attached to the watermark-embedded encoded content.

### BACKGROUND OF THE INVENTION

1. Field of the Invention

This invention relates to a method and apparatus for embedding information in content, a method and apparatus for reconstructing content, and a method and apparatus for extracting information from content.

2. Description of the Related Art

In order to prove that content is one's own copyright or property, there is a method of embedding copyright information or ownership information in content as a digital watermark. Generally, in accordance with this method, what information has been embedded and in what part of the content it has been embedded cannot be ascertained at a glance. When content in which copyright information or the like has been embedded is utilized unlawfully (as by being copied and re-distributed) by another party, i.e., without the permission of the copyright holder, the fact that the content has been re-distributed (i.e., that the content is one's own property) can be demonstrated if the copyright information is extracted from the content in which it has been embedded. The end result is that unauthorized use of content can be suppressed.

Subject matter in which information typifying copyright information is embedded as a digital watermark is content (such as image data and music data) that can be utilized even with the copyright information embedded in it. Programs and compressed data cannot be the recipient of embedded copyright information. The reason for this is that when information is embedded in a program or compressed data, the program or compressed data cannot be run on a computer and, hence, cannot be utilized.

### DISCLOSURE OF THE INVENTION

Accordingly, an object of the present invention is to provide an information embedding method and apparatus in which not only image data and music data but also programs and compressed data can be the recipient of embedded information.

Another object of the present invention is to provide a content reconstruction method and apparatus for obtaining the original content from content in which information generated by the above-mentioned information embedding method and apparatus has been embedded.

A further object of the present invention is to provide a method and apparatus for extracting information, which has been generated by the above-mentioned information embedding method and apparatus, from content in which this information has been embedded.

Yet another object of the present invention is to provide a method of distributing content in which information has been embedded by the above-mentioned information embedding method and apparatus.

A method of embedding information in content according to the present invention comprises the steps of generating first encoded content by attaching an error correction code to original content, and generating watermark-embedded encoded content by executing an embedding operation in which watermark data of such data length that the watermark data can be removed if decoding processing is executed using the error correction code is embedded in the first encoded content.

An apparatus for embedding information in content according to the present invention comprises encoded content generating means for generating first encoded content by attaching an error correction code to original content, and watermark-embedded encoded content generating means for generating watermark-embedded encoded content by executing an embedding operation in which watermark data of such data length that the watermark data can be removed if decoding processing is executed using the error correction code is embedded in the first encoded content.

Content includes programs, text data, still-image data, moving-image data, music (sound) data, data obtained by compressing this data, and various information represented by combinations of this data (multimedia data). Encoded content is obtained by attaching an error correction code to this content by executing encoding processing (error-correction encoding processing). The encoded content generally is generated in a form in which check bits have been added to the content.

Watermark data is embedded in encoded content. The watermark data typically is data representing characters, data representing an image, etc. Various information such as the content creator, the owner of content, the name of the user to which content is distributed and the date of content creation can be expressed by the character or image, etc., represented by the watermark data. Encoded content in which such watermark data has been embedded is watermark-embedded encoded content.

In accordance with the present invention, an error correction code is attached beforehand to content in which watermark data has been embedded (namely the watermark-embedded encoded content). Content can be obtained from the watermark-embedded encoded content, therefore, by using this error correction code. More specifically, watermark data to be embedded in encoded content can be positioned as an error. If this error is corrected (if decoding processing and error correction decoding processing is executed) using the error correction code, therefore, the error (the watermark data) can be removed from the watermark-embedded encoded content, thereby making it possible to obtain the original content.

In accordance with ordinary digital watermark techniques, content in which watermark data has been embedded is utilized by a user. (For example, image data in which copyright information has been embedded is distributed and is utilized by a user.) That is, what is actually utilized by the user is content in a state in which watermark data has been embedded. By contrast, in accordance with the present invention, content (watermark-embedded encoded content) in which watermark data has been embedded using an error correction code can be restored to the original content. This means that the user is capable of utilizing the content itself.

By way of example, assume that watermark-embedded encoded content to be distributed is content that has been obtained by attaching an error correction code to image data or music data and embedding watermark data in this data. In such case the watermark-embedded encoded content can be restored to content and therefore a user can be provided with images and music the quality of which will not decline. Furthermore, even if watermark-embedded encoded content is a program or compressed data, etc., in which watermark data has been embedded, the user can utilize this content as is (i.e., the user can use the program or data obtained by expanding the compressed data). Thus, according to the present invention, irrespective of the data format of content in which watermark data is to be embedded, i.e., regardless of whether the data format of the content is ordinary data, a program or compressed data, watermark data can be embedded in this content and the user can utilize the content per se.

A method of attaching an error correction code to content and a decoding method for obtaining original content from watermark-embedded encoded content correspond. That is, encoded content is generated by (error correction) encoding processing in accordance with a specific error correction encoding algorithm (error correction method), and the encoded content is subjected to an embedding operation. In a case where original content is reconstructed, (error correction) decoding processing in accordance with an error correction decoding algorithm corresponding to the specific error correction encoding algorithm is applied to the watermark-embedded encoded content.

The watermark data has such data length that the watermark data can be removed if decoding processing is executed using the error correction code. It will suffice to decide a data length (amount of data, number of bits, bit length) for the watermark data in accordance with the error correction capability of the error correction encoding (method) used. If decoding processing using the error correction code is applied to watermark-embedded encoded content in which such watermark data has been embedded, the watermark-embedded encoded content can be restored to the original content correctly.

Watermark data can also be extracted from watermark-embedded encoded content. With regard to watermark-embedded encoded content that has been generated by executing an embedding operation for embedding watermark data, which has such data length that the watermark data can be removed if decoding processing is executed using an error correction code, in first encoded content generated by attaching the error correction code to original content, the original content is reconstructed by subjecting this watermark-embedded encoded content to decoding processing using the attached error correction code. Second encoded content is generated by attaching the above-mentioned error correction code to the reconstructed original content. By applying an operation that is the reverse of the above-mentioned embedding operation to the second encoded content and watermark-embedded encoded content, watermark data that has been embedded in the watermark-embedded encoded content is extracted. The first encoded content and the second encoded content are the same.

In a case where watermark data is extracted, an operation (the above-mentioned reverse operation) corresponding to the watermark-data embedding operation (embedding processing) is executed. In one embodiment, first encoded content is generated by attaching an error correction code to original content and an exclusive-OR operation is calculated between the generated first encoded content and watermark data of such data length that the watermark data can be removed if decoding processing is executed using the error correction code. A combination of code sequence obtained by the exclusive-OR calculation and the above-mentioned encoded content is adopted as watermark-embedded encoded content. In this case, the original content is reconstructed by applying decoding processing to the watermark-embedded encoded content using the error correction code that has been attached. By calculating the exclusive-OR between the second encoded content and the watermark-embedded encoded content, the watermark data that has been embedded in the watermark-embedded encoded content is extracted. In this embodiment, the exclusive-OR operation is an operation that is the reverse of the embedding operation. For example, if the watermark data is data (a name, etc.) relating to the content creator, then, even if the watermark-embedded encoded content is copied and distributed by a third party, extracting the watermark data from the watermark-embedded encoded content will make it possible to readily prove that the watermark-embedded encoded content that has been distributed is the property (copyrighted material) of the creator.

It may be so arranged that the watermark data is embedded in the first encoded content at a plurality of locations thereof. This means that even if part of the watermark-embedded encoded content is lost, it is highly likely that the watermark data can be extracted in full. An arrangement may be adopted in which the watermark data is divided into a plurality of data segments and the plurality of data segments thus obtained by division are embedded in the first encoded content at a plurality of locations thereof.

The embedding of information in content can also be performed as follows: A method of embedding information in content according to the present invention includes steps of dividing original content into a plurality of data blocks each of a processing unit length, and attaching an error correction code to at least one of the plurality of data blocks. By embedding watermark data, which has such a data length that the watermark data can be removed if decoding processing is executed using the error correction code, in a data block to which the error correction code has been attached, a watermark-embedded encoded data block is generated. The plurality of data blocks inclusive of the watermark-embedded encoded data block that has been generated are arrayed in the original order. (Of course, if the plurality of data blocks obtained by division are processed in order, the data blocks inclusive of the watermark-embedded encoded data block will naturally become arrayed in the original order.) The data lengths (processing unit lengths) of the plurality of data blocks may be the same or may be different from one another. It is preferred that error correction code be attached to all of the data blocks.

The watermark-embedded encoded content may be divided into a plurality of data segments and the plurality of data segments obtained by division may be embedded in a plurality of data blocks to which error correction code has been attached. Data representing a single watermark is constituted by a combination of data segments (part of the watermark data) that have been embedded in each of the plurality of data blocks. The watermark data can be embedded by being dispersed throughout the content. Preferably, at least one data segment is embedded in all of the data blocks to which the error correction code has been attached.

It goes without saying that even in a case where watermark data (a data segment) has been embedded in a data block obtained by dividing content, the data length of the watermark data (the data segment) embedded is decided in accordance with the error correction capability in this data block.

The present invention further provides a method of distributing watermark-embedded encoded content from one computer to other computers, and a computer suited to this method.

A method of distributing content according to the present invention comprises executing the following steps in a content distributing computer: generating encoded content by attaching an error correction code to original content; generating watermark-embedded encoded content by executing embedding processing in which watermark data of such data length that the watermark data can be removed if decoding processing is executed using the error correction code is embedded in the encoded content that has been generated; and distributing the watermark-embedded encoded content that has been generated to a receiving computer; and executing the following step in a receiving computer that has received the watermark-embedded encoded content: subjecting the watermark-embedded encoded content to decoding processing using an error correction code that has been attached thereto, thereby reconstructing original content.

A content distributing computer suited to the above-described method comprises: encoded content generating means for generating encoded content by attaching an error correction code to original content; watermark-embedded encoded content generating means for generating watermark-embedded encoded content by executing an embedding operation in which watermark data of such a data length that that the watermark data can be removed if decoding processing is executed using the error correction code is embedded in the encoded content that has been generated; and distribution means for distributing the watermark-embedded encoded content that has been generated by the watermark-embedded encoded content generating means to a receiving computer in response to a content distribution request from the receiving computer.

A receiving computer suited to the above-described method comprises: receiving means for receiving watermark-embedded encoded content generated by executing an embedding operation in which watermark data of such data length that the watermark data can be removed if decoding processing is executed using error correction code is embedded in encoded content that has been generated by attaching the error correction code to original content, the watermark-embedded encoded content being distributed from a content distributing computer; and means for reconstructing the original content by subjecting the watermark-embedded encoded content that has been received to decoding processing using the error correction code that has been attached to the watermark-embedded encoded content.

In a preferred embodiment, the above-described content distributing computer and receiving computer are interconnected via a network. In a case where the content distributing computer and receiving computer construct a client/server system, the content distributing computer is positioned as a server and the receiving computer is positioned as a client.

The content distributing computer (referred to simply as a “server” below) attaches an error correction code to content to thereby generate encoded content. Watermark data is embedded in the encoded content. The receiving computer (referred to simply as a “client” below) accepts the watermark-embedded encoded content. The acceptance of the watermark-embedded encoded content by the client may be through a mode in which the content is downloaded from the server or a mode in which the content is received by broadcast-type transmission from the server. Since the watermark-embedded encoded content includes error correction code, the client can obtain the content, from which the watermark data has been removed, if the client subjects the watermark-embedded encoded content to decoding processing based upon the error correction code.

Preferably, it is so arranged that the user of the client cannot copy and re-distribute the content per se that is obtained by the client. For example, a program for decoding watermark-embedded encoded content is marked up in a set-up program that stores (sets up) original content, which has been obtained by decoding, in a storage device of a client executably, and the set-up program is distributed to the client from the server. By executing the set-up program at the client, content is obtained from the watermark-embedded encoded content and the content obtained is set up at the client (i.e., is stored in the storage device). Since the content per se is stored in the storage device of the client in a state in which it cannot be extracted from the client, re-distribution of the content by the user is prevented.

The set-up program may include a routine that allows the client to execute processing for decoding encrypted data or processing for expanded compressed data. If watermark-embedded encoded content has been distributed upon being encrypted, the watermark-embedded encoded content is decoded by the set-up program and stored in the storage device. If watermark-embedded encoded content has been distributed upon being compressed, the watermark-embedded encoded content is expanded by the set-up program and stored in the storage device.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a block diagram illustrating the electrical structure of an embedding apparatus according to the present invention;

FIG. 2 is a block diagram illustrating another example of the electrical structure of an embedding apparatus according to the present invention;

FIG. 3 is a block diagram illustrating still another example of the electrical structure of an embedding apparatus according to the present invention;

FIG. 4 is a flowchart illustrating the flow of processing of an embedding program;

FIG. 5 is a block diagram illustrating the electrical structure of a decoder;

FIG. 6 is a flowchart illustrating the flow of processing of a decoding program;

FIG. 7 is a block diagram illustrating the electrical structure of a watermark data extraction unit;

FIG. 8 is a conceptual view illustrating the relationship between embedding processing and extraction processing corresponding to this embedding processing;

FIG. 9 is a block diagram illustrating another example of the electrical structure of a watermark data extraction unit;

FIG. 10 is a flowchart illustrating the flow of processing of a program for extracting watermark data;

FIG. 11 illustrates the overall configuration of a content distributing system according to the present invention;

FIG. 12 is a flowchart illustrating the flow of processing of a set-up program;

FIG. 13a illustrates content in the form of bits and FIG. 13b illustrates content and a parity sequence in the form of bits;

FIG. 14 illustrates encoded content;

FIG. 15 illustrates the manner in which watermark-embedded encoded content is created;

FIG. 16 illustrates watermark-embedded encoded content;

FIG. 17 illustrates the manner in which content is obtained from watermark-embedded encoded content; and

FIG. 18 illustrates the manner in which watermark data is extracted from watermark-embedded encoded content.

### DESCRIPTION OF THE PREFERRED EMBODIMENT

A preferred embodiment of the present invention will now be described in detail with reference to the drawings.

(1) Embedding Apparatus

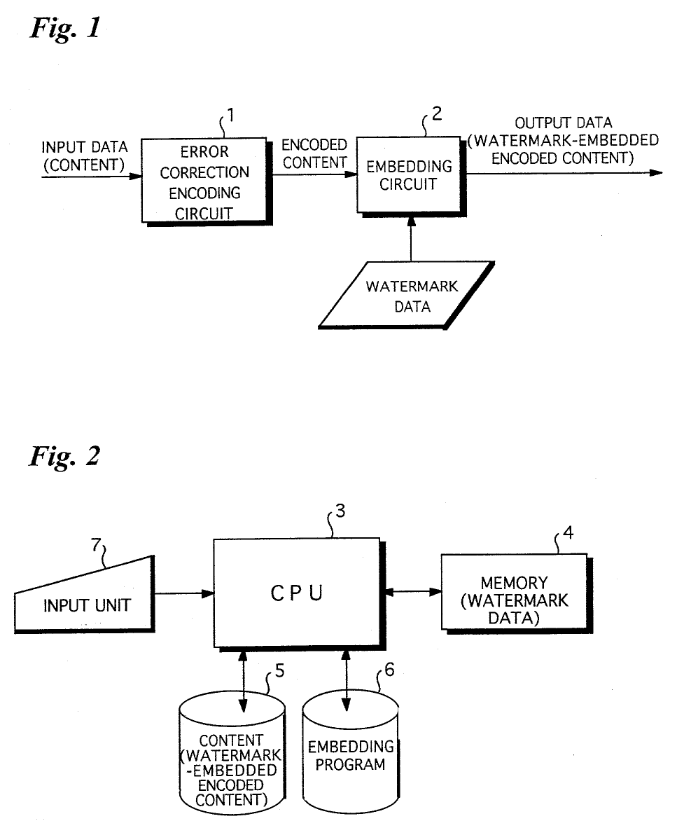

FIGS. 1 to 3 are block diagrams schematically illustrating hardware implementations of embedding apparatus for embedding prescribed data in content. The implementations of embedding apparatus shown in FIGS. 1 to 3 each generate encoded content by attaching an error correction code to content and embed watermark data in the encoded content that has been generated. The watermark data embedded in the encoded content includes data representing various information such as data (referred to as “copyright information” below) representing the name of the content copyright holder and the content date of creation, etc., and data (referred to as “user information” below) representing the name, etc., of the user to which the content is distributed.

Various information such as music, images and text is included in content in which watermark data is to be embedded. In addition to ordinary data (data utilizable as is), other data formats of data representing the above items of information include the format of compressed data that can be utilized by executing expansion processing [e.g., MP3 (MPEG-1 Audio Layer 3) data, ATRAC (Adaptive Transform Acoustic Coding) data, Twin VQ (Transform-domain weighted interleave Vector Quantization) data, JPEG (Joint Photographic Experts Group) data and GIF (Graphics Interchange Format) data], Programs (operating systems, application programs and utility programs, etc.) are also included as examples of content. The embedding apparatus is for embedding watermark data in content such as such ordinary data, compressed data and programs.

The embedding apparatus shown in FIG. 1 includes an error correction encoding circuit 1 and an embedding circuit 2. Input data (content) is input to the error correction encoding circuit 1, which then attaches error correction code (i.e., executes encoding processing and error correction encoding processing) to the input data (content). The error correction encoding circuit 1 outputs the content to which the error correction code has been attached (this content is encoded content). The encoded content that is output from the error correction encoding circuit 1 is input to the embedding circuit 2. Also input to the embedding circuit 2 is watermark data. The embedding circuit 2 embeds the watermark data in the encoded content. The embedding circuit 2 outputs the encoded content in which the watermark data has been embedded (this content shall be referred to as “watermark-embedded encoded content”).

The embedding apparatus shown in FIG. 2 includes a CPU (central processing unit) 3, an input unit 7, a storage device 5 in which content has been stored, a storage device 6 in which an embedding program has been stored, and a memory 4 that provides a working area, etc.

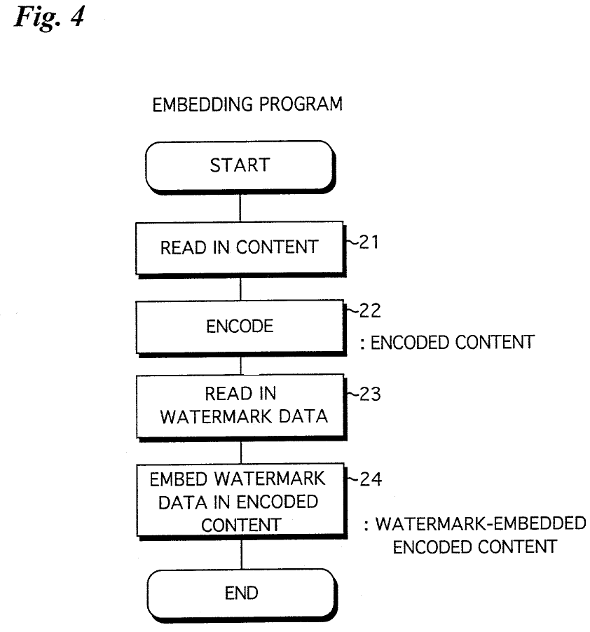

FIG. 4 is a flowchart illustrating the flow of processing of the embedding program has been stored storage device 6. When the embedding program is launched, content is read out of the storage device 5 and is stored temporarily in the memory 4 (step 21). An error correction code is attached to the content that has been stored temporarily in the memory 4. Encoded content is obtained (step 22).

Watermark data is applied to the memory 4 (e.g., from the input unit 7) (step 23). The watermark data is embedded in the encoded content, which has been stored in memory 4, whereby watermark-embedded encoded content is generated (step 24). Following prescribed exit processing (e.g., storage of watermark-embedded encoded content in the storage device 5), processing of the embedding program ends.

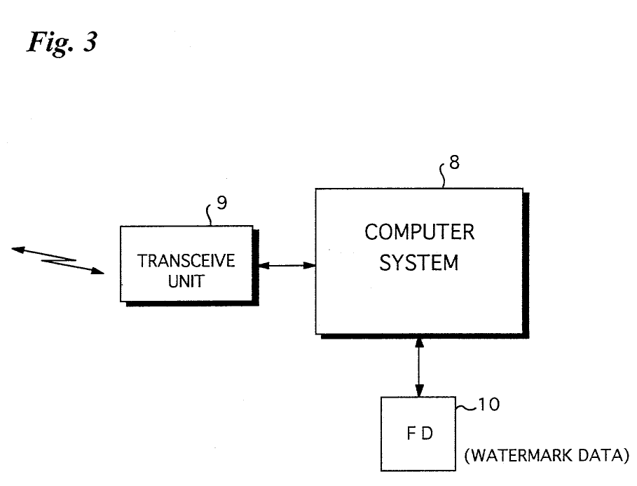

The embedding apparatus shown in FIG. 3 includes a computer system 8, a transceive unit 9 and a floppy disk (FD) 10 on which watermark data has been recorded. The computer system 8 is a system (a personal computer or workstation, etc.) that includes a CPU, a storage device, an input unit, a display unit, a floppy-disk drive, a CD-ROM drive and an input/output interface.

Content and an embedding program have been stored in the storage device (not shown) of the computer system 8. The computer system 8 functions as an embedding apparatus in response to execution of an embedding program (see FIG. 4). Content that has been stored in the storage device of the computer system 8 is encoded. Furthermore, watermark data that has been recorded on the floppy disk 10 is embedded in the encoded content to thereby generate watermark-embedded encoded content. The watermark-embedded encoded content that has been generated is stored in the storage device of the computer system 8.

The computer system 8 is capable of being connected to a network such as the Internet via the transceive unit 9. For example, a request to download watermark-embedded encoded content is transmitted from another computer system, which is connected to the network, to the computer system 8, and the download request is received by the transceive unit 9. The computer system 8 responds by reading the watermark-embedded encoded content, whose downloading has been requested, out of the storage device. The watermark-embedded encoded content read out of the storage device is transmitted via the transceive unit 9 to the computer system that requested download. It is not necessarily required that watermark-embedded encoded content be stored in the storage device in advance. The embedding program may be launched to generate the watermark-embedded encoded content from content whenever download is requested.

(2) Decoder

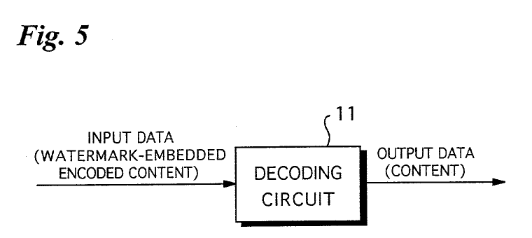

FIG. 5 is a block diagram schematically illustrating a hardware implementation of a decoder for restoring watermark-embedded encoded content, which has been generated by the above-describe embedding apparatus (FIGS. 1 to 3), to the original content.

The decoder includes a decoding circuit 11. The decoding circuit 11 is a decoding processing circuit for detecting error data (noise) contained in input data and correcting the error data to correct data (i.e., removes noise from the input data). Detection and correction of the error data is based upon an error correction code contained in the input data.

Watermark-embedded encoded content generated by an embedding apparatus is input to the decoding circuit 11.

In a case where input data that enters the decoding circuit 11 is content per se, the decoding circuit 11 outputs the content per se. However, the watermark-embedded encoded content input to the decoding circuit 11 is the result of embedding watermark data in encoded content generated by attaching an error correction code to content. The decoding circuit 11, therefore, determines that error data (noise) is mixed in with the content. That is, the decoding circuit 11 subjects the watermark-embedded encoded content to decoding processing (error correction processing and error correction decoding processing). The algorithm of the decoding processing executed by the decoding circuit 11 corresponds to that of the encoding processing executed in the embedding apparatus (FIGS. 1 to 3).

The decoding circuit 11 detects error data (noise) contained in the watermark-embedded encoded content and corrects the error data (removes the noise) based upon the error correction code. As a result, the output data from the decoding circuit 11 represents content that is free of error (the error correction code also is removed). Content, therefore, is output from the decoding circuit 11.

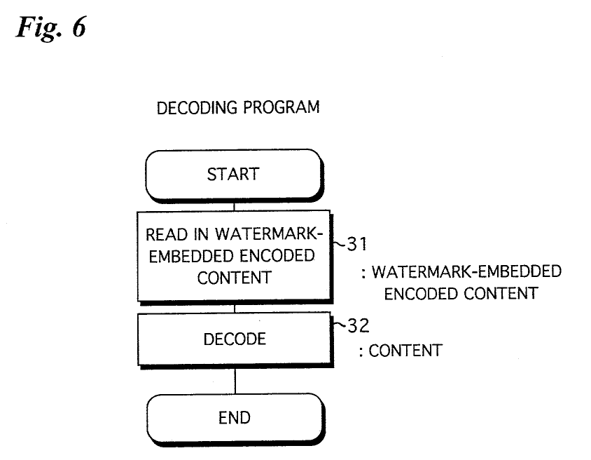

The hardware implementation shown in FIG. 2 also can be applied as a decoder. In this case also the watermark-embedded encoded content is stored in the storage device 5. A decoding program is stored in the storage device 6. A flowchart illustrating the flow of processing of the decoding program is shown in FIG. 6. The decoding program reads watermark-embedded encoded content that has been stored in the storage device 5 out of this storage device (step 31) and stores the same temporarily in memory 4. Decoding processing is applied to the watermark-embedded encoded content that has been stored temporarily in the memory 4 (step 32). On the basis of error correction code included in the watermark-embedded encoded content, watermark data (and the error correction code) that has been embedded in the watermark-embedded encoded content is removed from the watermark-embedded encoded content. Content is thus obtained. This content is stored in storage device 5.

The hardware implementation shown in FIG. 3 also can be applied as a decoder. Here watermark-embedded encoded content and a decoding program are stored in the storage device of computer system 8. When the decoding program is executed, the computer system 8 functions as a decoder. On the basis of the error correction code included in the watermark-embedded encoded content, the watermark data (and error correction code) is removed from the watermark-embedded encoded content. Content is thus obtained.

(3) Watermark Data Extraction Unit

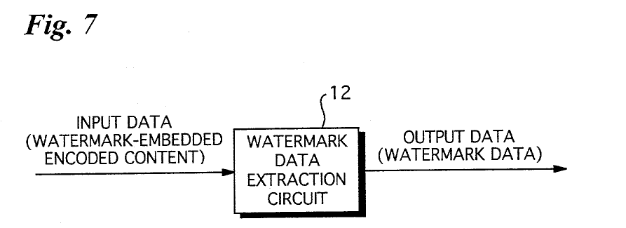

FIG. 7 is a block diagram illustrating an example of a hardware implementation of a watermark data extraction unit for extracting watermark data, which has been embedded in watermark-embedded encoded content, from the watermark-embedded encoded content generated by the above-described embedding apparatus (FIGS. 1 to 3).

The watermark data extraction unit includes a watermark data extraction circuit 12. Watermark-embedded encoded content is input to the watermark data extraction circuit 12 as input data. The watermark data extraction circuit 12 extracts the watermark data, which has been embedded in the watermark-embedded encoded content, from the entered watermark-embedded encoded content, and outputs the extracted watermark data.

By executing extraction processing corresponding to embedding processing performed by the embedding apparatus, the watermark data extraction unit (watermark data extraction circuit 12) extracts the watermark data from the watermark-embedded encoded content. In general, an operation that is the reverse of the operation for watermark-data embedding processing in the embedding apparatus is performed by the watermark data extraction unit (watermark data extraction circuit 12).

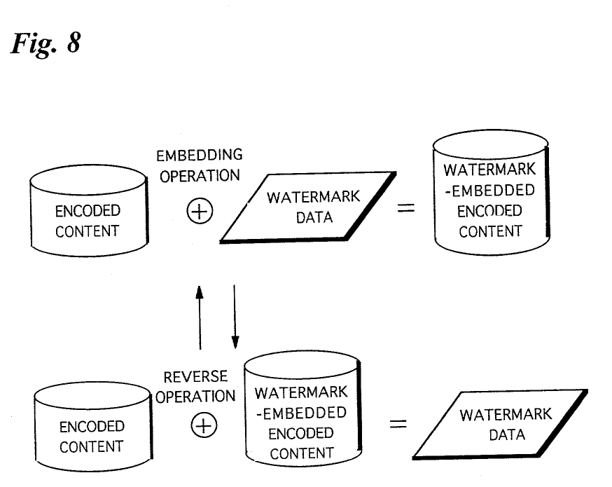

FIG. 8 conceptually illustrates an example of processing for embedding watermark data and processing, which corresponds to this embedding processing, for extracting the watermark data.

A case where the exclusive-OR between encoded content and watermark data is calculated and the result of this calculation is adopted as watermark-embedded encoded content will be taken as an example of the embedding processing executed by the embedding apparatus (see the top of FIG. 8). If the exclusive-OR between encoded content and watermark data is calculated in this case, the result will represent the watermark data (see the bottom of FIG. 8). This exclusive-OR operation for extracting the watermark data is positioned as an operation that is the reverse of the operation for embedding the watermark data.

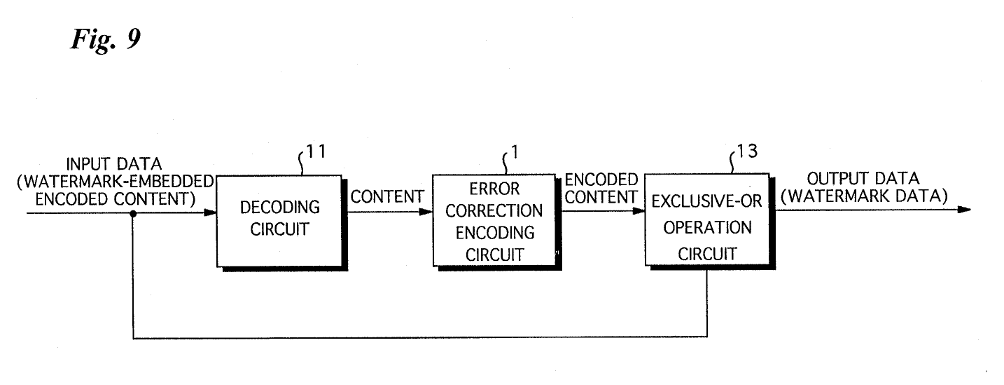

FIG. 9 is a block diagram illustrating a hardware implementation of a watermark data extraction unit for executing the watermark data extraction processing shown at the bottom of FIG. 8. The watermark data extraction unit shown in FIG. 9 includes the decoding circuit 11, the error correction encoding circuit 1 and an exclusive-OR circuit 13. The decoding circuit 11 is the same as that (the decoder) shown in FIG. 5, and the error correction encoding circuit 1 is the same as that (the embedding apparatus) shown in FIG. 1. The details of the circuits 11, 1 will not be described again in order to avoid prolixity.

The watermark-embedded encoded content (input data) is input to the decoding circuit 11 and also to the exclusive-OR circuit 13. The decoding circuit 11 removes watermark data from the watermark-embedded encoded content, thereby producing content. The content that is output from the decoding circuit 11 is applied to the error correction encoding circuit 1. The latter attaches error correction code to the content to produce encoded content. The encoded content output from the error correction encoding circuit 1 also is input to the exclusive-OR circuit 13.

The exclusive-OR circuit 13 calculates the exclusive-OR between the encoded content and watermark-embedded encoded content. Since the watermark-embedded encoded content was obtained from the exclusive-OR between the encoded content and watermark data, the exclusive-OR between the encoded content, which is output from the exclusive-OR circuit 13, and the watermark-embedded encoded content becomes the watermark data (see FIG. 8). This completes the extraction of the watermark data.

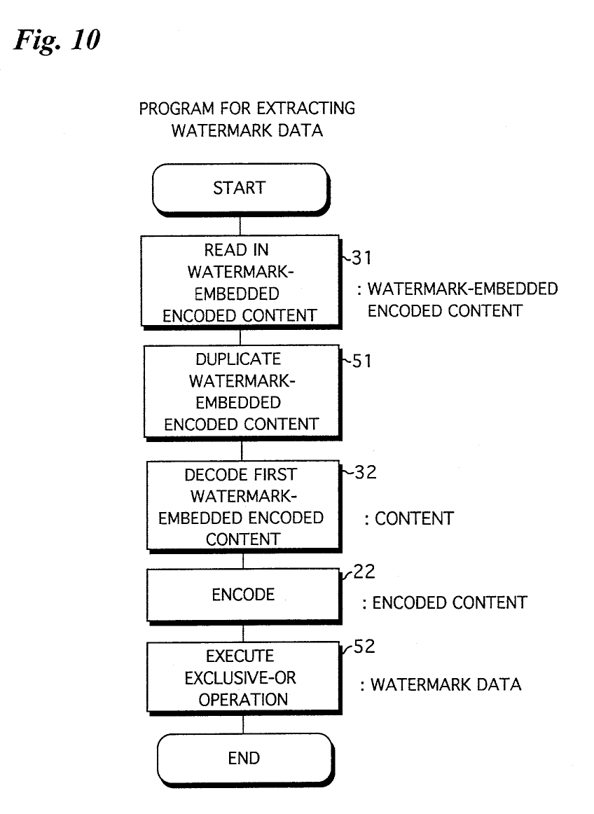

The hardware implementation shown in FIG. 2 also can be applied as a unit for executing the processing of the watermark-data extraction unit shown in FIG. 9. In this case, watermark-embedded encoded content is stored in the storage device 5 and a program for extracting watermark data is stored in the storage device 6. FIG. 10 illustrates the flow of processing executed by the program for extracting watermark data. Since this program includes processing identical with that of the above-described decoding program (FIG. 6) and embedding program (FIG. 4), the processing that is identical with that of FIGS. 6 and 4 will be designated by like step numbers and will not be described in detail again in order to avoid prolixity.

The program for extracting watermark data reads watermark-embedded encoded content that has been stored in the storage device 5 out of this storage device (step 31) and stores the same temporarily in memory 4. The watermark-embedded encoded content is duplicated in memory 4 (step 51), whereby identical first and second watermark-embedded encoded content is obtained. Decoding processing is applied to the first watermark-embedded encoded content (step 32) and the second watermark-embedded encoded content is stored in memory 4 as is.

An error correction code is attached to the content obtained from the watermark-embedded encoded content by decoding processing, whereby encoded content is generated (step 22). Finally, the exclusive-OR is calculated between the second watermark-embedded encoded content that has been stored in the memory 4 and the encoded content generated via the decoding processing and encoding processing (step 52). The watermark data is obtained as a result.

(4) Applications

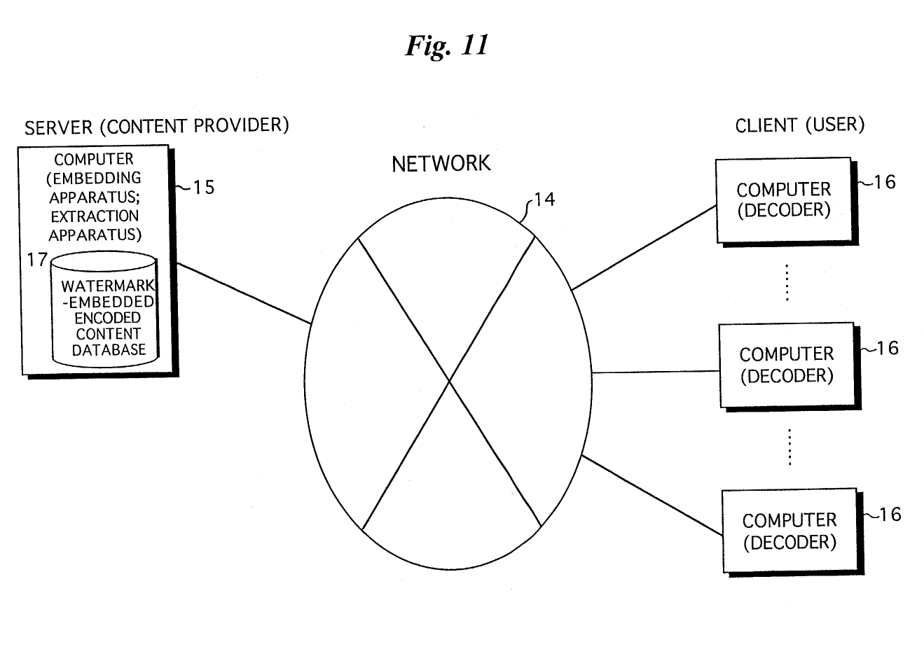

FIG. 11 illustrates the overall configuration of a content distributing system according to the present invention. A content distributing system is a system through which a content provider uses a communication channel (a wired or wireless communication channel) to provide various content to users. The content distribution system comprises a server computer 15 and a plurality of client computers 16 interconnected via a network 14. In this embodiment, it is assumed that the server computer 15 is under the control of the content provider and that the client computers 16 are under the control of users who utilize the content provided by the content provider.

The server computer 15 and client computers 16 are computer systems (personal computers, workstations, etc.) that include such equipment as a storage device for storing programs and data, etc., a transceive device for transmitting-receiving programs and data, etc., an input unit for inputting data, etc., and a display unit for displaying data. The network 14 may be a public line (such as the Internet) or a leased line provided between these computer systems. The facilities and equipment (CATV facilities, broadcast satellites and communication satellites, etc.) used in these lines are also included in the network 14. Communications programs employed in the sending and receiving of data and the like have been stored in the storage devices of the server computer 15 and client computers 16. A browser can be used as the communications program installed in the client computers 16.

The storage device of the server computer 15 is further provided with a watermark-embedded encoded content database 17. Watermark-embedded encoded content, which has been obtained by encoding content and embedding watermark data (copyright information and user information, etc.) in this encoded content has been stored in the watermark-embedded encoded content database 17. The watermark-embedded encoded content is that generated by the above-described embedding apparatus. The watermark-embedded encoded content may be generated in the server computer 15 [in such case the server computer 15 is equipped with the embedding apparatus (or program)], or the watermark-embedded encoded content, which has been generated in another computer, may be stored in the storage device (watermark-embedded encoded content database 17) of the server computer 15. Furthermore, the server computer 15 is equipped with a watermark-data extraction unit (or program).

By using the communications program (browser, etc.), the client computers 16 are capable of accessing the watermark-embedded encoded content database 17 provided in the storage device of the server computer 15. Each client computer 16 includes the above-described decoder (or decoding program). The decoder executes decoding processing that corresponds to the embedding processing applied to generation of the watermark-embedded encoded content that has been stored in the server computer 15.

Watermark-embedded encoded content downloaded from the server computer 15 to the client computer 16 via the network 14 is restored to content by executing decoding processing in the client computer 16. Even if the watermark-embedded encoded content is the result of encoding a program or compressed data and embedding watermark data therein, the program or compressed data (content) itself can be obtained by the client computer 16. The watermark-embedded encoded content transmitted from the server computer 15 is content that can be run on the client computer 16.

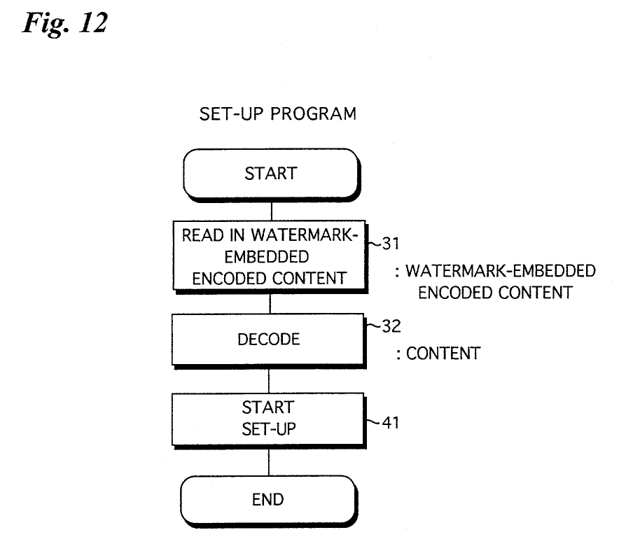

FIG. 12 is a flowchart illustrating the flow of processing of a set-up program in a portion of which is included the processing (see FIG. 6) of the above-described decoding program. This set-up program is a program that is distributed together with an application program and application data in which watermark data has been embedded by the embedding apparatus (i.e., watermark-embedded encoded content). The set-up program is a program for generating content (application program and application data) by removing watermark data from watermark-embedded encoded content by applying decoding processing to the watermark-embedded encoded content, and setting up the obtained application program and application data in the storage device of a computer system (i.e., for moving the application program and application data to the storage device of the computer system and recording the directory information thereof in a main directory). Processing shown in FIG. 12 that is identical with the processing of the decoding program (FIG. 6) is designated by like step numbers and need not be described again.

The set-up program and watermark-embedded encoded content are transmitted from the server computer 15 to the client computer 16 via the network 14 and a transceive circuit. Of course, an arrangement may be adopted in which a portable recording medium such as a CD-ROM on which the set-up program and watermark-embedded encoded content have been recorded by the content provider is loaded in the CD-ROM drive of the client computer.

When the set-up program is launched, execution of the set-up program starts.

Watermark-embedded encoded content is read into the memory of client computer 16 (step 31) and decoding processing is applied to the watermark-embedded encoded content that has been read into the memory (step 32). The application program and application data (content) from which the watermark data has been removed are obtained. Set-up of the obtained application program and application data in the computer system starts (step 41).

In a case where processing (decoding processing) for generating content from watermark-embedded encoded content is to be executed as part of the set-up program processing, the user of the client computer 16 that executes the set-up program can utilize the content that has been set up by causing the client computer 16 to execute the content. However, the user cannot separately extract the content. The reason for this is that the set-up program executes, as a whole, processing (decoding processing) for obtaining content by removing watermark data from watermark-embedded encoded content and processing for setting up (installing) the obtained content in the computer system; when the content is set up in the client computer 16, the program and data that have been set up can no longer be restored to the original state (the state that prevailed prior to set-up). The program and data that have been set up in the client computer 16 can be utilized only in the computer system used in set-up (or only in another computer system connected to the above computer system by a server/client). By thus incorporating decoding processing in processing of the set-up program, it is possible to prevent an unauthorized act, such as the re-distribution of content from which watermark data has been removed, by the user of the client computer 16.

If, in a case where watermark-embedded encoded content has been re-distributed by a user, the re-distributed watermark-embedded encoded content can be acquired and the watermark data can be extracted from the watermark-embedded encoded content using the watermark-data extraction unit of the server computer 15 and it is found that the watermark data is copyrighted information (or ownership information), then the content provider can claim to possess the copyright (or the content). In a case where the watermark data is user information (name, ID, etc.) of the user of the client computer 16 to which the content is distributed, then the user performing the re-distribution can be identified. This makes it possible to prevent unauthorized utilization of watermark-embedded encoded content.

In the arrangement described above, the server computer 15 is equipped with the embedding apparatus and watermark-data extraction unit. However, separate computers may be equipped with respective ones of these. Further, in the arrangement described above, all of the client computers 16 (users) are equipped with a decoder (decoding program). However, it may be so arranged that the decoder (decoding program) is given only to a specific user to which the decoding of watermark-embedded encoded content has been allowed by the content provider.

It goes without saying that the device that accepts distribution of watermark-embedded encoded content is not limited to a computer system (client computer 16). A cellular telephone, electronic directory, portable music playback device, game machine and other electronic devices may be provided with the processing function of the above-described client computer 16 (decoder).

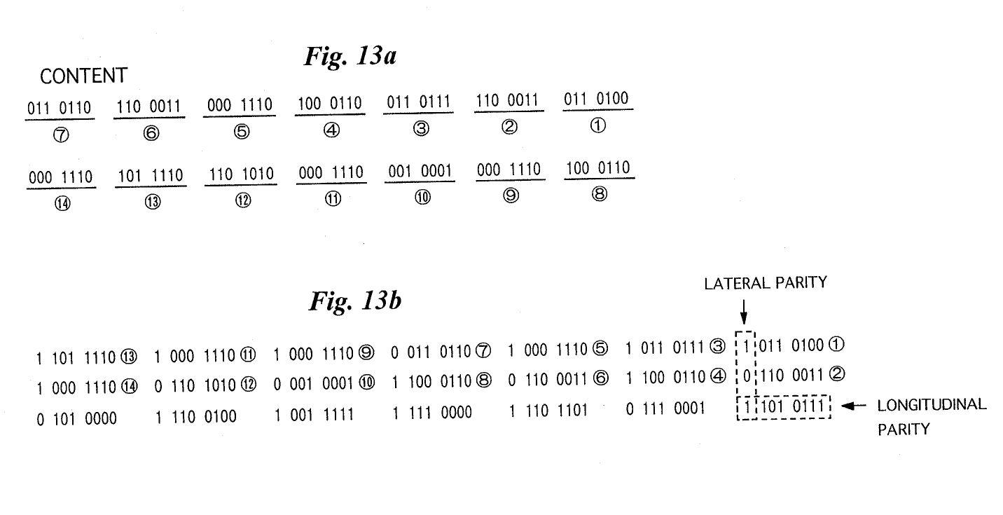

The flow of creation (generation) of watermark-embedded encoded content by the embedding apparatus (FIGS. 1 to 3) and the flow of watermark-data extraction by the watermark-data extraction unit (FIG. 7) will now be described in greater detail. FIGS. 13 to 16 illustrate the flow of creation of watermark-embedded encoded content. Data (or a program) composed of a 98-bit sequence of bits will be taken as an example of content. In order to facilitate an understanding of this aspect of the invention, the bit sequence of 98 bits representing content is illustrated in FIG. 13a in a form in which it is partitioned into 14 blocks (first block, second block, . . . 14^{th} block) of seven bits each. The first (rightmost) bit, second bit, third bit, fourth bit, fifth bit, sixth bit and seventh bit of each block shall be referred to as bit 0, bit 1, bit 2, bit 3, bit 4, bit 5 and bit 6, respectively.

First, error correction code is attached to content (encoding is performed). Here an example using orthogonal parity (lateral parity and longitudinal parity) will be described as an example of attaching (encoding) error correction code.

As shown in FIG. 13b, 1-bit lateral parity (1 or 0) is attached as the least significant bit of each block of seven bits each [i.e., as an eighth bit (bit 7)]. The lateral parity attached to each block depends upon the number of “1”s included in the first bit (bit 0) to seventh bit (bit 6) of each block. When the number of “1”s included in bits 0 to 6 is even, parity of “0” is attached to bit 7 of each block. When the number of “1”s included in bits 0 to 6 is odd, parity of “1” is attached to bit 7 of each block.

For example, bits 0 to 6 of the first block include three “1”s (i.e., an odd number of “1”s) (“0110100”) and therefore parity of “1” is attached as the least significant bit (bit 7) of the first block (“1 0110100”).

Next, the exclusive-OR is taken bit by bit of bits at corresponding bit positions of the following block pairs: the first and second blocks, the third and fourth blocks, the fifth and sixth blocks, the seventh and eighth blocks, the ninth and tenth blocks, the 11^{th} and 12^{th} blocks and the 13^{th} and 14^{th} blocks. For example, when the exclusive-OR is taken of each of the corresponding bits of the bit sequence (“1 0110100”) of the first block and the bit sequence (“0 1100011”) of the second block to which lateral parity has been attached, an 8-bit sequence “1 1010111” is generated. Each of the eight bits calculated by the exclusive-OR is used as longitudinal parity.

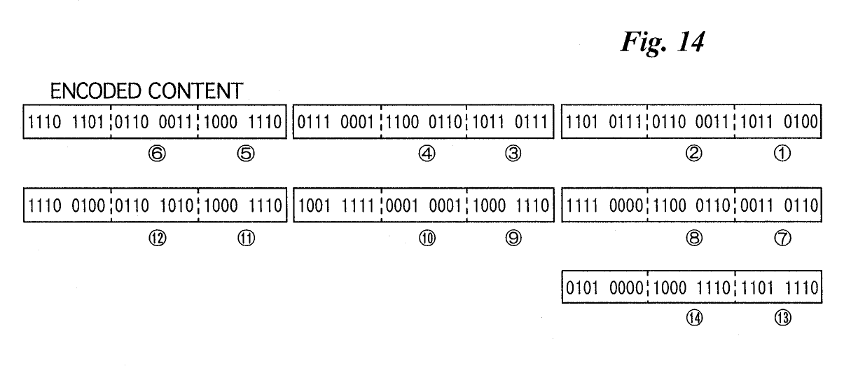

Each bit sequence (longitudinal parity sequence) of eight bits generated by the exclusive-OR is inserted following the lower-order block of the two blocks that were used in the generation of the respective bit sequence. For example, the longitudinal parity sequence “1 1010111” generated by the exclusive-OR between the first and second blocks is inserted following the second block (“1 1010111 0 1100011 1 0110100”) (see FIG. 14). The bit sequences (enclosed by the borders in FIG. 14) of 24 bits each composed of two blocks and the generated longitudinal parity sequence shall be referred to as “encoded blocks” (first encoded block, second encoded block, . . . seventh encoded block). The bit sequence of 168 bits composed of the seven encoded blocks, namely the first to seventh encoded blocks, is encoded content that corresponds to the content shown in FIG. 13a.

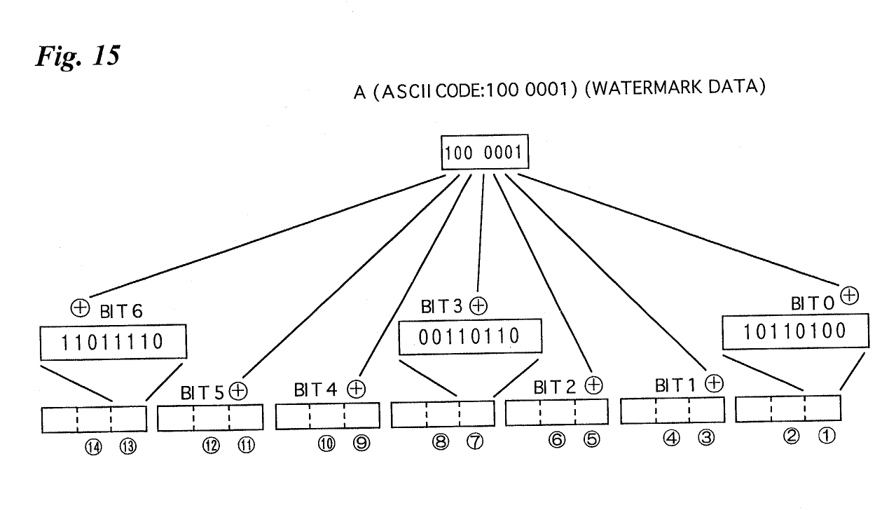

After the encoded content is generated, control proceeds to processing for embedding watermark data in this encoded content (processing for generating watermark-embedded encoded content). Reference will be had to FIG. 15 to describe an example in which data (ASCII code “1000001”) representing the letter “A” of the alphabet is embedded in encoded content composed of the seven encoded blocks, namely the first to seventh encoded blocks, described above.

The bits of the 7-bit data (=1000001) representing “A” are assigned to respective ones of the seven encoded blocks, with the bit data (=1) of the first bit (bit 0) of the 7-bit data (=1000001) representing “A” being assigned to the first encoded block, the bit data (=0) of the second bit (bit 1) being assigned to the second encoded block, and so on. The exclusive-OR is calculated between the assigned bit data and the bit data in each encoded block that is at the bit position corresponding to the bit position of this assigned bit data. The calculated bit data is substituted for the original bit data of the encoded block.

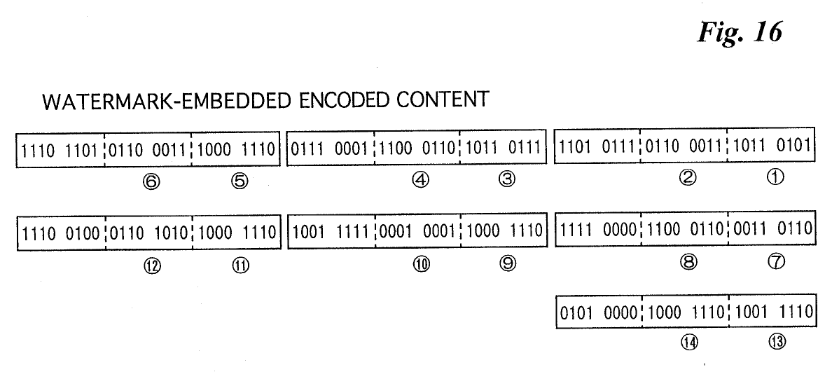

For example, the exclusive-OR is calculated between the bit data (=1) of the first bit (bit 0) of the 7-bit data (=1000001) representing “A” and the bit data (=0) of bit 0 of the first encoded block. The exclusive-OR between “1” and “0” is “1”. The bit data of bit 0 of the first encoded block is rewritten from “0” to “1” (see FIGS. 14 and 16). Likewise, the exclusive-OR is calculated, for example, between the bit data (=0) of the fourth bit (bit 3) of the 7-bit data (=1000001) representing “A” and the bit data (=0) of bit 3 of the fourth encoded block. The exclusive-OR between “0” and “0” is “0”. The bit data of bit 3 of the fourth encoded block remains “0”.

Thus, the end result is that the bit data of the first bit (bit 0) of the first block is rewritten from “0” to “1” and the bit data of the seventh bit (bit 6) of the seventh block is rewritten from “1” to “0”, as shown in FIG. 16. The bit sequence of 168 bits composed of the seven encoded blocks, namely the first to seventh encoded blocks, that results following execution of watermark-data embedding processing is the watermark-embedded encoded content that corresponds to the content shown in FIG. 13a.

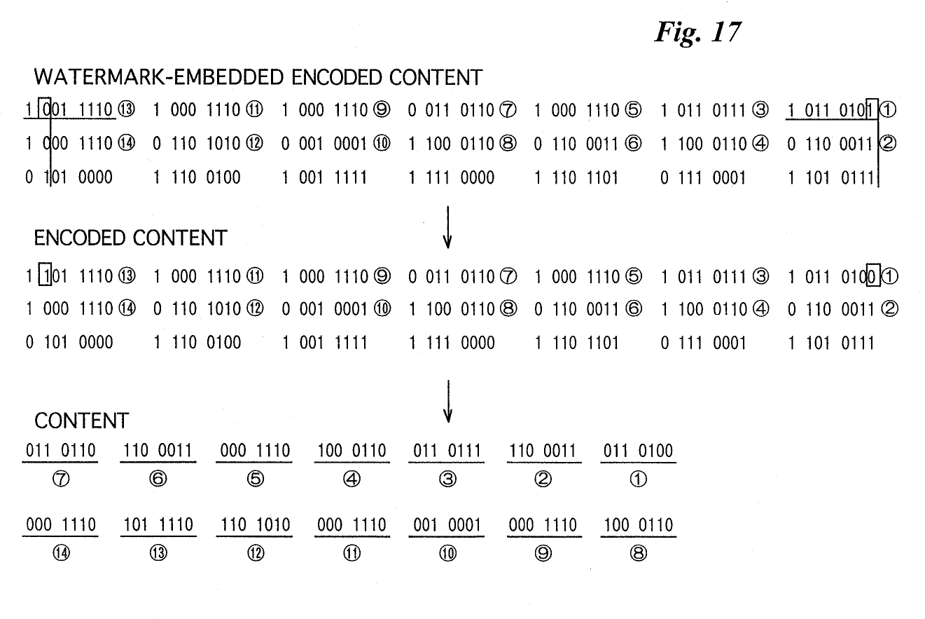

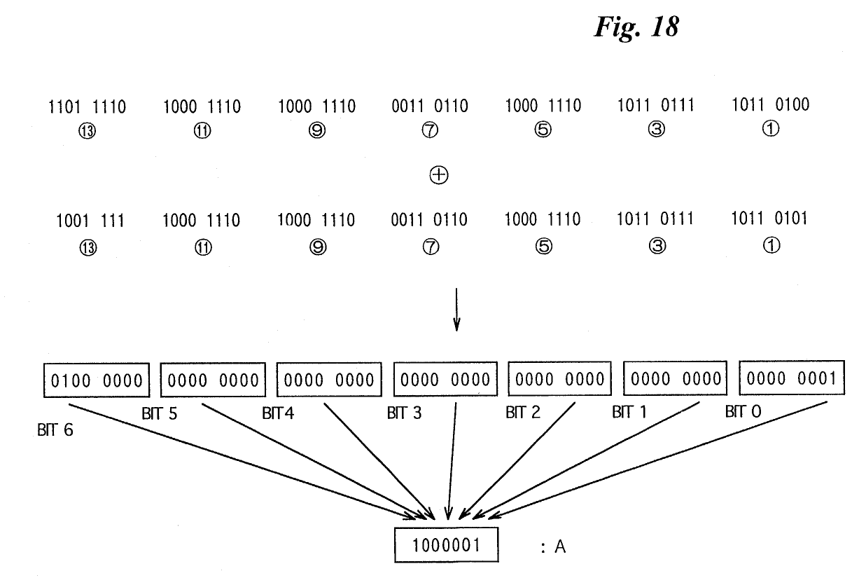

FIGS. 17 and 18 illustrate the details of the flow of processing for extracting watermark data. These diagrams shown the manner in which the watermark data (“A”) is extracted from the watermark-embedded encoded content shown in FIG. 16.

Attention will be directed to the first encoded block in the watermark-embedded encoded content [namely the first block (=1 0110101), the second block (=0 110 0011) and the longitudinal parity sequence (=1 1010111) that was calculated based upon the first block (=1 0110101) and second block (=0 110 0011) in the processing for generating the encoded content]. Regardless of the fact that the exclusive-OR between the bit data (“1” and “1”) of the first bits (bit 0) of respective ones of the first block (=1 0110101) and second block (=0 110 0011) in the watermark-embedded encoded content is “0”, the bit data of bit 0 of the longitudinal parity sequence is “1”. It will be understood, therefore, that the bit data (=1) of bit 0 of the first block or the bit data (=1) of bit 0 of the second block is erroneous.

Attention will now be directed to the least significant bits (lateral parity) of the first block (=1 0110101) and second block (=0 110 0011). The bits 0 to 6 of the first block include four (an even number of) “1”s. When an even number of “1”s is included, the least significant bit of the first block is “1”, regardless of the fact that the least significant bit (lateral parity) should be “0”. Thus the fact that the first block contains an erroneous bit is detected.

It is understood, therefore, that bit 0 of the first block is erroneous.

Such error detection processing is applied similarly to each of the second to seventh encoded blocks. It is detected that there is also an error in the seventh (bit 6) bit of the 13^{th} block (=1 0011110) contained in the seventh encoded block (see the top of FIG. 17).

When an error is detected, the particular item of bit data is corrected. Specifically, the bit of bit 0 in the first block is corrected from “1” to “0”, and the bit of bit 6 in the 13^{th} block is corrected from “0” to “1”. Encoded content is obtained (see the middle of FIG. 17).

If the longitudinal parity and lateral parity are extracted from the data sequence composed of the 1^{st} to 14^{th} blocks that have undergone such processing, the result will represent the original content (the same as that of FIG. 13a) (decoding processing; see the bottom of FIG. 17).

In embedding processing, the exclusive-OR between encoded content and watermark data is calculated and the result is utilized to obtain watermark-embedded encoded content. Accordingly, when the exclusive-OR is calculated between the encoded content and the watermark-embedded encoded content (i.e., when the reverse operation is performed), the watermark data can be extracted.

The watermark-data extraction unit executes watermark-data extraction processing (the above-mentioned reverse operation) that corresponds to the embedding processing in the embedding apparatus. The exclusive-OR is calculated bit by bit between the corresponding bits of the blocks in which the watermark data is embedded in the encoded content (the first, third, fifth, seventh, ninth, 11^{th} and 13^{th} blocks) and each corresponding block of the watermark-embedded encoded content. A bit sequence of 56 bits is generated. From each of the seven blocks of the first to seventh blocks obtained by partitioning this sequence into intervals of eight bits each, the bit of bit 0 of the first block, the bit of bit 1 of the second block, the bit of bit 2 of the third block, the bit of bit 3 of the fourth block, the bit of bit 4 of the fifth block, the bit of bit 5 of the sixth block and the bit of bit 6 of the seventh block are extracted and arranged in order. When this is done, the data sequence (=“1000001”) will represent the watermark data (“A”). This completes the extraction of the watermark data (see FIG. 18).

In addition to the orthogonal parity codes, it is possible to use other codes such as convolutional code, cyclic code and BCH code as the error correction code. Further, the watermark data need not necessarily be embedded over the entirety of content (encoded content); it may be so arranged that the watermark data is embedded in part of the content (i.e., locally). Further it may be so arranged that watermark data is embedded at a plurality of locations (i.e., redundantly) in content.

As many apparently widely different embodiments of the present invention can be made without departing from the spirit and scope thereof, it is to be understood that the invention is not limited to the specific embodiments thereof except as defined in the appended claims.

What is claimed is:

1. A method of embedding information in content, comprising the steps of:
generating first encoded content by attaching an error correction code to original content; and
generating watermark-embedded encoded content by executing an embedding operation in which watermark data of such data length that the watermark data can be removed if decoding processing is executed using the error correction code is embedded in the first encoded content.

2. A content reconstruction method comprising the step of decoding original content by subjecting watermark-embedded encoded content, which has been generated by the method set forth in claim 1, to decoding processing using an error correction code that has been attached to the watermark-embedded encoded content.

3. An information extraction method comprising the steps of:
generating second encoded content by attaching the error correction code to original content that has been reconstructed by the method set forth in claim 2; and
extracting watermark data, which has been embedded in the watermark-embedded encoded content, by applying an operation that is the reverse of the embedding operation to the second encoded content and the watermark-embedded encoded content.

4. The method according to claim 1, wherein the watermark data is embedded in the first encoded content at a plurality of locations thereof.

5. The method according to claim 1, further comprising the steps of:
dividing the watermark data into a plurality of data segments; and
embedding the plurality of data segments in the first encoded content at a plurality of locations thereof.

6. A method of embedding information in content, comprising the steps of:
dividing original content into a plurality of data blocks each of a processing unit length;
attaching an error correction code to at least one of the plurality of data blocks;
generating a watermark-embedded encoded data block by embedding watermark data, which has such a data length that the watermark data can be removed if decoding processing is executed using the error correction code, in the data block to which the error correction code has been attached; and
arraying the plurality of data blocks, which include the watermark-embedded encoded data block that has been generated, in the original order.

7. The method according to claim 6, further comprising the steps of:
dividing the watermark data into a plurality of data segments; and
embedding the plurality of data segments in a plurality of data blocks to which error correction code has been attached.

8. The method according to claim 7, wherein at least one data segment is embedded in all data blocks to which error correction code has been attached.

9. A method of embedding information in content, comprising the steps of:
generating first encoded content by attaching an error correction code to original content; and
calculating the exclusive-OR between the first encoded content that has been generated and watermark data of such data length that the watermark data can be removed if decoding processing is executed using the error correction code; and
adopting a combination of a code sequence, which has been obtained by calculation of the exclusive-OR, and the first encoded content as watermark-embedded encoded content.

10. An information extraction method comprising the steps of:
decoding original content by subjecting watermark-embedded encoded content, which has been generated by the method set forth in claim 9, to decoding processing using an error correction code that has been attached to the watermark-embedded encoded content;
generating second encoded content by attaching the error correction code to the original content that has been reconstructed; and
extracting watermark data, which has been embedded in the watermark-embedded encoded content, by calculating the exclusive-OR between the second encoded content and the watermark-embedded encoded content.

11. A method of embedding information, comprising the steps of:
generating encoded data, an encoded program or encoded compressed data by attaching an error correction code to data, a program or compressed data; and
generating watermark-embedded encoded data, a watermark-embedded encoded program or watermark-embedded encoded compressed data by executing an embedding operation in which watermark data of such data length that the watermark data can be removed if decoding processing is executed using the error correction code is embedded in the encoded data, encoded program or encoded compressed data that has been generated.

12. An apparatus for embedding information in content, comprising:
encoded content generating means for generating encoded content by attaching an error correction code to original content; and
watermark-embedded encoded content generating means for generating watermark-embedded encoded content by executing an embedding operation in which watermark data of such data length that the watermark data can be removed if decoding processing is executed using the error correction code is embedded in the encoded content that has been generated.

13. An apparatus for reconstructing content, comprising:
means for inputting watermark-embedded encoded content that has been generated by executing embedding processing in which watermark data of such data length that the watermark data can be removed if decoding processing is executed using error correction code is embedded in encoded content that has been generated by attaching the error correction code to original content; and
means for reconstructing the original content by subjecting the watermark-embedded encoded content, which has been input from said input means, to decoding processing using the error correction code that has been attached to the watermark-embedded encoded content.

14. The apparatus according to claim 13, further comprising set-up means for storing the reconstructed original content in a storage device;
wherein said means for reconstructing the original content is included in said set-up means.

15. An information extraction apparatus comprising:
means for inputting watermark-embedded encoded content that has been generated by executing an embedding operation in which watermark data of such data length that the watermark data can be removed if decoding processing is executed using error correction code is embedded in first encoded content that has been generated by attaching the error correction code to original content;
reconstruction means for reconstructing the original content by subjecting the watermark-embedded encoded content, which has been input from said input means, to decoding processing using the error correction code that has been attached to the watermark-embedded encoded content;
encoded content generating means for generating second encoded content by attaching the error correction code to the original content that has been reconstructed by said reconstruction means; and
extraction means for extracting the watermark data, which has been embedded in the watermark-embedded encoded content, by applying an operation that is the reverse of the embedding operation to the second encoded content and the watermark-embedded encoded content.

16. A method of distributing content, comprising the following steps executed in a content distributing computer:
generating encoded content by attaching an error correction code to original content;
generating watermark-embedded encoded content by executing an embedding operation in which watermark data of such data length that the watermark data can be removed if decoding processing is executed using the error correction code is embedded in the encoded content that has been generated; and
distributing the watermark-embedded encoded content to a receiving computer; and
executing the following step in a receiving computer that has received the watermark-embedded encoded content:
subjecting the watermark-embedded encoded content to decoding processing using an error correction code that has been attached thereto, thereby reconstructing original content.

17. The method according to claim 16, further comprising a step, executed in said content distributing computer, of distributing to said receiving a computer a program for controlling said receiving computer so as to reconstruct original content from the watermark-embedded encoded content and set up the reconstructed original content in a client computer.

18. A content distributing computer comprising:
encoded content generating means for generating encoded content by attaching an error correction code to original content;
watermark-embedded encoded content generating means for generating watermark-embedded encoded content by executing an embedding operation in which watermark data of such data length that the watermark data can be removed if decoding processing is executed using the error correction code is embedded in the encoded content that has been generated; and
distributing means for distributing the watermark-embedded encoded content that has been generated by said watermark-embedded encoded content generating means to a receiving computer in response to a content distribution request from said receiving computer.

19. A receiving computer comprising:
receiving means for receiving watermark-embedded encoded content generated by executing an embedding operation in which watermark data of such data length that the watermark data can be removed if decoding processing is executed using error correction code is embedded in encoded content that has been generated by attaching the error correction code to original content, the watermark-embedded encoded content being distributed from a content distributing computer; and
means for reconstructing the original content by subjecting the watermark-embedded encoded content that has been received to decoding processing using the error correction code that has been attached to the watermark-embedded encoded content.

20. The receiving computer according to claim 19, further comprising set-up means for storing the reconstructed original content in a storage device;
wherein said means for reconstructing the original content is included in said set-up means.

21. A computer-readable recording medium on which has been recorded a program for controlling a computer so as to:
generate encoded content by attaching an error correction code to original content; and
generate watermark-embedded encoded content by executing an embedding operation in which watermark data of such data length that the watermark data can be removed if decoding processing is executed using the error correction code is embedded in the encoded content that has been generated.

22. A computer-readable recording medium on which has been recorded a decoding program for controlling a computer so as to decode original content by subjecting watermark-embedded encoded content, which has been generated by executing an embedding operation in which watermark data of such data length that the watermark data can be removed if decoding processing is executed using error correction code is embedded in first encoded content that has been generated by attaching the error correction code to original content, to decoding processing using the error correction code that has been attached to the watermark-embedded encoded content.

23. A computer-readable recording medium on which has been recorded a set-up program, which includes the decoding program set forth in claim 22, for controlling a computer so as to store reconstructed original content in a storage device.

24. The recording medium according to claim 22, on which has been recorded an extraction program for controlling a computer so as to:
generate second encoded content by attaching the error correction code to the original content that has been reconstructed; and
extract watermark data, which has been embedded in the watermark-embedded encoded content, by applying an operation that is the reverse of the embedding operation to the second encoded content and the watermark-embedded encoded content.
